(19) United States
(12) Patent Application Publication
(10) Pub. No.: US 2015/0317353 A1
(43) Pub. Date: Nov. 5, 2015

(54) CONTEXT AND ACTIVITY-DRIVEN PLAYLIST MODIFICATION

(71) Applicant: AT&T Intellectual Property I, L.P., Atlanta, GA (US)

(72) Inventor: Eric Zavesky, Austin, TX (US)

(73) Assignee: AT&T Intellectual Property I, L.P., Atlanta, GA (US)

(21) Appl. No.: 14/268,590

(22) Filed: May 2, 2014

(51) Int. Cl. G06F 17/30

(52) U.S. Cl. CPC G06F 17/30386

(57) ABSTRACT

A method of dynamically modifying a playlist includes obtaining, at a device, context data including information indicating a context associated with a user and obtaining, at the device, activity data including information indicating an activity of the user. The method also includes adding a media content item to a playlist, wherein the content item is added to the playlist based on information descriptive of the media content item, the context data, and the activity data. The method further includes setting, at the device, a playback parameter of the media content item based on the context data, the activity data, or any combination thereof.

### FIELD OF THE DISCLOSURE

The present disclosure is generally related to dynamic modification of a playlist of media content.

### BACKGROUND

Users of electronic devices have shown a preference for media playlists or streams that are personalized for their needs, which can depend on mood, location, or time of day. Several services create playlists for users. These services generally determine user preferences based on direct user input or feedback. For example, a service may use a seed input from the user to begin playlist generation. The seed input is used to select one or more initial songs for the playlist. Subsequently, songs selected for the playlist are modified based on user feedback regarding particular songs.

### BRIEF DESCRIPTION OF THE DRAWINGS

FIG. 1 is a diagram to illustrate a particular embodiment of a system including an electronic device that is operable to dynamically modify a playlist based on context data and activity data;

FIG. 2 is a diagram to illustrate a particular embodiment of the electronic device of FIG. 1;

FIG. 3 is a diagram to illustrate a particular embodiment of the context data of FIG. 1;

FIG. 4 is a diagram to illustrate a particular embodiment of the activity data of FIG. 1;

FIG. 5 is a diagram to illustrate a particular embodiment of a method of sending a dynamically modified playlist from a first device to a second device;

FIG. 6 is a flowchart to illustrate a particular embodiment of a method of dynamically modifying a playlist based on context data and activity data; and

FIG. 7 illustrates a block diagram of a computer system to modify a playlist based on context data and activity data.

### DETAILED DESCRIPTION

Embodiments disclosed herein dynamically select media (e.g., audio, video, or both) for a playlist based on activity data indicating user interactions (e.g., within a home or with a mobile device) along with information related to the user's media preferences. The user interactions can be detected based on user activities (e.g., turning on lights, changing the temperature, opening doors, etc.), speech interactions (e.g., the tone of someone's conversations on a phone or face-to-face, who is speaking, content of the speech), passive computer-vision observations (such as with in-home cameras, e.g., to determine if someone is excited or tired, to observe facial expressions, or to observe activity in the user's environment), passive health-based observations (such as those from heart-rate monitors), and digital activities (e.g., phone calls or emails, media purchases from music/video stores, channel-change information from a media service). To illustrate, activity data may indicate interaction events, such as a type of communication performed using a communication device, content of a communication sent via the communication device, content of a communication received via the communication device, a frequency of communication via the communication device, an address associated with a communication sent by the communication device, an address associated with a communication received by the communication device, or any combination thereof.

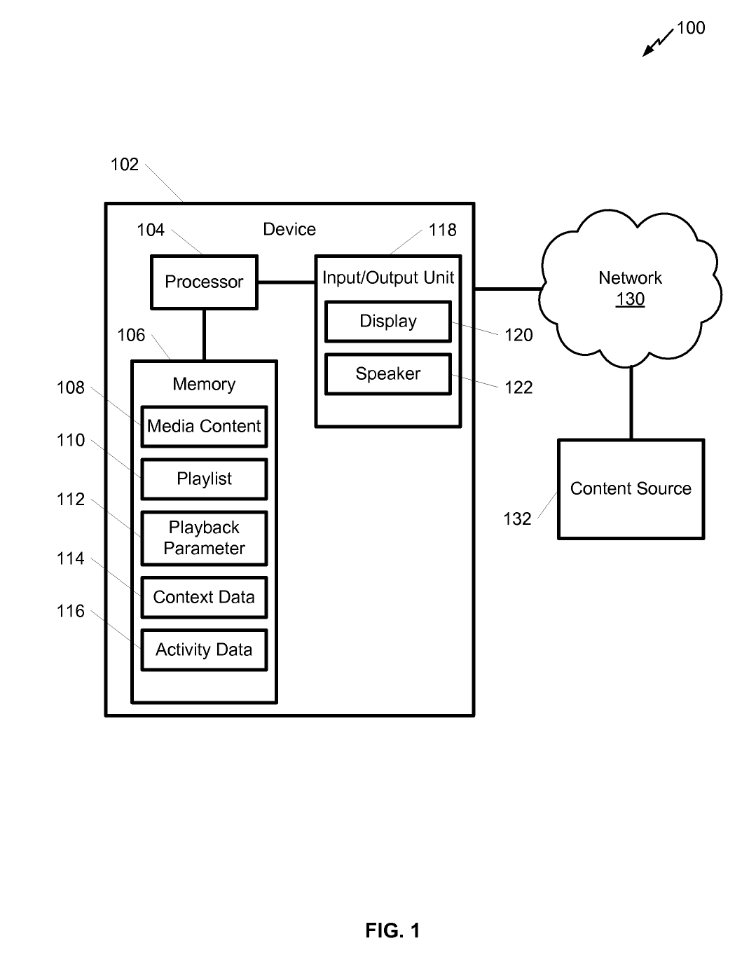

Referring to FIG. 1, a particular illustrative embodiment of a system 100 is shown. The system 100 includes a device 102 (e.g., a computing device) coupled via a network 130 to a content source 132. The device 102 includes a processor 104 coupled to a memory 106. The device 102 also includes an input/output unit 118 coupled to the processor 104. The input/output unit 118 includes a display 120 and a speaker 122. In a particular embodiment, the input/output unit 118 corresponds to a touch screen display that can display output and receive user input. The memory 106 stores media content 108, a playlist 110, one or more playback parameters 112, context data 114, and activity data 116. The media content 108 may include one or more audio files, video files, multimedia files, or any combination thereof. The media content 108 may include media content item(s) received from the content source 132. For example, the content source 132 may be a service accessible via the internet, where the service provides media files for downloading and/or streaming. The media file(s) may be downloaded from the content source 132 via the network 130 and stored at the memory 106 as the media content 108.

During operation, the device 102 may obtain the context data 114 including information indicating a context associated with a user of the device 102. For example, the device 102 may be a communication device, such as a wireless communication device (e.g., smartphone or tablet computing device), and the context data 114 may include a geographic location of the device 102. In other embodiments, the context data 114 may correspond to or represent a point of interest that is proximate to the device 102, a movement of the device 102, a travel mode of the user (e.g., walking, driving, etc.), a calendar or schedule of the user, a weather status associated with the geographical location of the device 102, a time (e.g., time stamp or time of day), a mood of the user, or any combination thereof. The mood of the user may be determined based on user input received at the device 102 or based on other information, such as information associated with an image of the user. For example, the electronic device 102 may include a camera that captures images of a user and the images of the user may be analyzed in order to determine whether the user is in a positive mood or a negative mood depending on facial recognition methods. As another example, a camera external to the device 102, such as a home security camera, may capture the image of the user.

The device 102 may also obtain activity data 116 including information indicating an activity of the user. The activity data 116 may indicate or otherwise correspond to an interaction event representing an interaction of the user with the device 102. For example, the activity data 116 may indicate a speech event corresponding to speech detected proximate to the user or proximate to the device 102. The activity data 116 may include content of the speech (e.g., based on execution of a speech recognition engine), a tone of the speech, a recognized speaker of the speech, or any combination thereof. For example, the input/output unit 118 may include a microphone that receives speech signals from a user or from another party proximate to the device 102. The processor 104 is responsive to the input/output unit 118 and may receive audio signals that include speech information and may process the speech information in order to identify a particular speaker, a type of speech, a tone of speech, or any combination thereof.

In a particular embodiment, the activity data 116 indicates a visual event corresponding to image information detected proximate to the user or the device 102. For example, a camera of the device 102, such as a still image camera or a video camera, may capture images and other content related to a visual event. The visual event may be indicated by data descriptive of a facial expression of the user, a facial expression of a person proximate to the user, an activity proximate to the user, an identification of a person proximate to the user, surroundings of the user, or any combination thereof.

The processor 104 of the device 102 receives and analyzes information descriptive of the media content 108 as well as the context data 114 and the activity data 116. Based on the information descriptive of the media content 108, the context data 114, and the activity data 116, the processor 104 may identify and add a media content item to a playlist. In addition, the processor 104 may set the playback parameter 112 at the device 102, where the playback parameter 112 corresponds to the media content item that has been added to the playlist 110. The processor 102 may set the playback parameter 112 based on the context data 114, the activity data 116, or both. In a particular example, the playback parameter 112 corresponds to a brightness of a video output, such as the brightness associated with display 120. Depending on a context or activity corresponding to the device 102, the playback parameter 112 (e.g., the brightness) of the display 120 may be adjusted. For example, the brightness may be reduced or turned off when the device 102 is playing a song without an accompanying video, or the brightness may be increased when the device 102 is playing a video in a bright environment. In another particular example, the playback parameter 112 corresponds to a volume of an audio output, such as the volume associated with the speaker 122. In yet another particular example, the playback parameter 112 corresponds to activation of visual (e.g., textual) captions, such as a caption overlay on the display 120. Depending on a context or activity corresponding to the device 102, the playback parameter 112 (e.g., the audio volume or the caption overlay) of the speaker 122 or the display 120 respectively may be adjusted. For example, in a particular environment, such as an indoor environment, the speaker volume may be adjusted to a low level, and the caption overlay may be disabled, whereas in an outdoor environment the speaker volume may be adjusted to a higher level and the caption overlay may be enabled. In another particular environment, the playback parameter 112 may be a playback speed of the media content 108 (e.g., audio content or video content), and the playback speed may be increased or decreased.

Information descriptive of the media content 108 may be determined by the processor 104 by analyzing the media content 108 to determine a plurality of characteristics of the media content 108. As an illustrative non-limiting example, the information descriptive of the media content 108 may include the playback duration of the media content 108 and a format of the media content 108.

In a particular embodiment, the device 102 is a mobile communication device and the activity data 116 corresponds to or represents an interaction or event with the mobile communication device. For example, the activity data 116 may indicate a type of communication performed using the mobile communication device, content of a communication sent via the mobile communication device, content of a communication received by the mobile communication device, a frequency of communication via the mobile communication device, an address associated with a communication sent by the mobile communication device, an address associated with a communication received by the mobile communication device, or any combination thereof.

In an example embodiment, the user may use the device 102 to play media content 108 while commuting to work. If the playlist 110 is currently empty, a new playlist may be generated and stored as the playlist 110. The context data 114 may be based on the nature of the user's commute including travel time or mode of transportation (e.g., via a train). For example, when the user travels by train for 30 minutes, the device 102 may determine that the user may want to listen to new music acquired from the content source 132 via the network 130. The playlist 110 may be modified (e.g., adding a new song or removing an old song) based on the determination that the user may want to listen to new music. Accordingly, the new music may be downloaded or streamed via the network 130 from the content source 132 to the device 102. When the user arrives at work, the device 102 may switch the media content 108 to music more appropriate to a work place, such as classical music from the content source 132.

Media preference may be determined based on the context data 114. Media preferences of the user may further be derived or determined based on the activity data 114. Additionally, or in the alternative, the media preferences may be derived based on other data, such as an owned/physical catalogue (music or movies on a hard disk, DVDs, a library, etc.), personal content (personal photos, videos, etc., in a memory), or direct user input. User preference information describing the media preferences of a user may be determined based on direct user input or may be inferred from user activity such as purchase information or online activity, or data from social media networks. Detection of media stored at the device 102 (or at a server) may also be used in order to determine the user preferences. Thus, various types of data, such as activity data and context data, are aggregated, and the aggregated data is coupled with media preferences of a user to create a customized playlist. Using the context data 114 and the activity data 116 to produce a customized playlist may reduce a burden on the user having to manually describe the user's own mood or type of content. The system also facilitates content discovery since the user does not have to sort through large content repositories, keep abreast of all newly released content, or experience repeated presentations of newly released content in various environments. The system facilitates customized media playback in different environments (home, car, mobile), by opportunistically utilizing a variety of available information.

The system 100 may include a recommendation engine to facilitate discovery of media content by the user. The system 100 may also include an analysis and understanding component to facilitate automated ingestion and processing of new media content so that the new media content can be appropriately recommended. The analysis and understanding component may process video and/or images to generate machine-understandable descriptions of the media content. For example, the machine-understandable descriptions may include a plurality of characteristics of a media content item, such as playback duration of the media content item, a format of the media content item, and learned textual descriptions (e.g., tags) that characterize the video and/or images that comprise the media content 108. The machine-understandable descriptions may be used as inputs to the recommendation engine. The recommendation engine may utilize the machine-understandable descriptions to search for media content that has similar descriptions or properties as the machine-understandable descriptions to create recommendations that are tailored to the user.

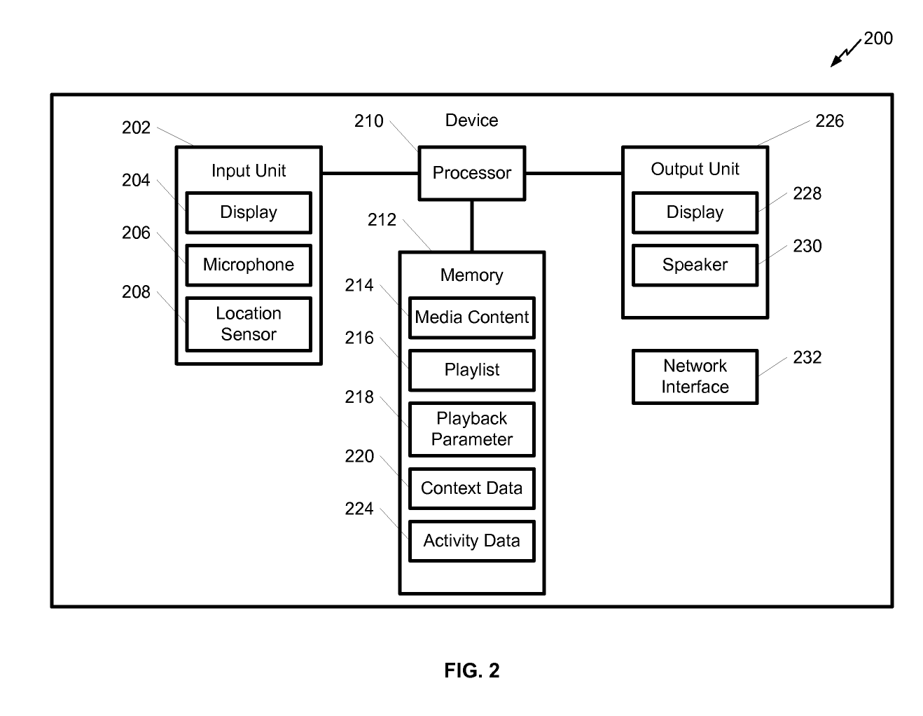

Referring to FIG. 2, a particular illustrative embodiment of a computing device 200 is shown. The computing device 200 may correspond to the device 102 of FIG. 1. The computing device 200 includes elements, such as the processor 210, the memory 212, and the output unit 226 that correspond to components described with reference to the device 102. The computing device 200 also includes a network interface 232. The computing device 200 includes an input unit 202 as well as an output unit 226.

The memory 212 stores media content 214, a playlist 216, a playback parameter 218, context data 220, and activity data 224. Each of the elements within the memory 212 corresponds to similar elements within the memory 106 as described with respect to FIG. 1.

The computing device 200 further includes components such as the touchscreen 204, the microphone 206, and the location sensor 208 within the input unit 202. In a particular embodiment, the location sensor 208 may be a global positioning satellite (GPS) receiver configured to determine and provide location information. In other embodiments, other methods of determining location may be used, such as triangulation (e.g., based on cellular signals or Wi-Fi signals from multiple base stations). The context data 220 may include, based on the location information from the location sensor 208, a geographic location of the computing device 200.

In one example, the activity data 224 may be determined by analyzing an audio input signal received by the microphone 206. For example, speaker information may be determined or extracted from audio input signals received by the microphone 206 and such speaker information may be included in the activity data 224 and may correspond to activity of a user or surroundings of the computing device 200.

The network interface 232 may include a communication interface, such as a wireless transceiver, that may communicate via a wide area network, such as a cellular network, to obtain access to other devices, such as the content source 132 of FIG. 1. In an example embodiment, the network interface 232 may determine whether sufficient network resources (e.g., bandwidth) are available. If insufficient network resources are available, the computing device 200 may limit use of an external content source (e.g., the content source 132 of FIG. 1). Thus, the computing device 200 includes processing capability, input and output capability, and communication capability in order to receive and evaluate context data, activity data, and information related to media content in order to customize a playlist on behalf of a user of the computing device 200.

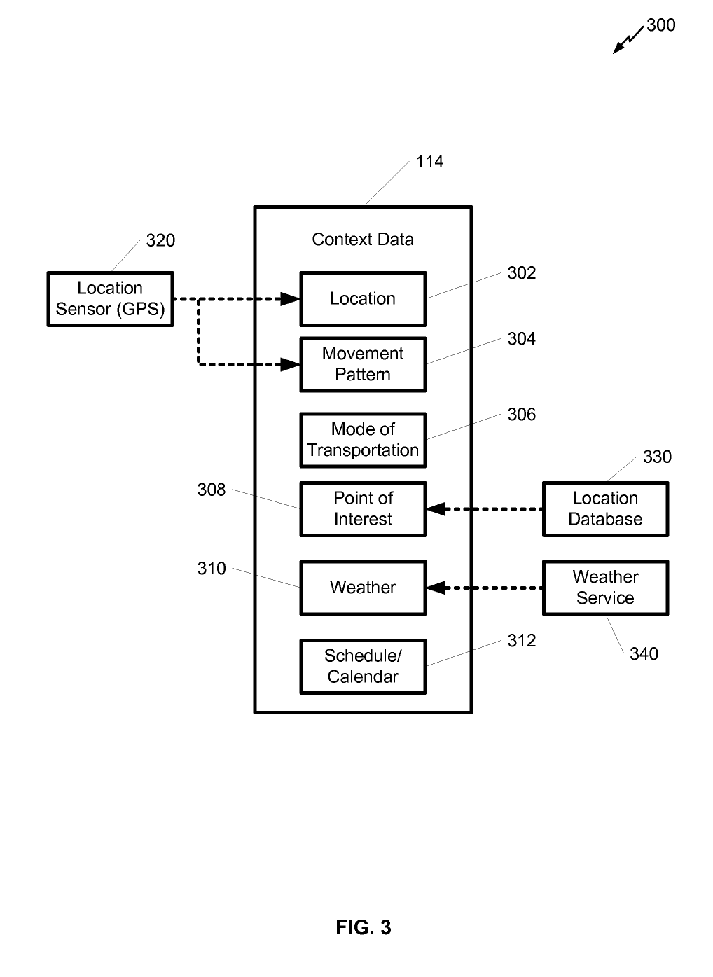

Referring to FIG. 3, further detail regarding illustrative examples of the context data 114 of FIG. 1 is shown and generally designated 300. The context data 114 may include location information 302 and movement pattern information 304 based on information received from a location sensor 320. The location sensor 320 may be a GPS receiver and may correspond to the location sensor 208 of FIG. 2. The context data 114 also includes mode of transportation information 306, point of interest information 308, weather information 310, and schedule or calendar information 312. In a particular embodiment, the point of interest information 308 may be received from a location database 330, and the weather information 310 may be received from a weather service 340.

The location database 330 may be external to a computing device (e.g., the device 102 or the computing device 200) and may receive a location request from the computing device via a network (e.g., the network 130). Similarly, the weather service 340 may be an internet based weather service that provides information to devices on a real-time or near real-time basis in order to provide updated weather information. Thus, the context data 114 may include a variety of different types of information related to a context of a device, such as the device 102 or the computing device 200.

The context data 114 may include information associated with a vehicle, such as a car or truck associated with the user. The vehicle may have environmental sensors configured to receive and evaluate environmental data associated with the vehicle. In an example, the environmental data may include information regarding weather conditions, ambient temperature inside or outside of the vehicle, traffic flow, or any combination thereof. Based on the environmental data, a particular media content item may be selected, such as a high tempo song being selected on a sunny day during fast-moving traffic.

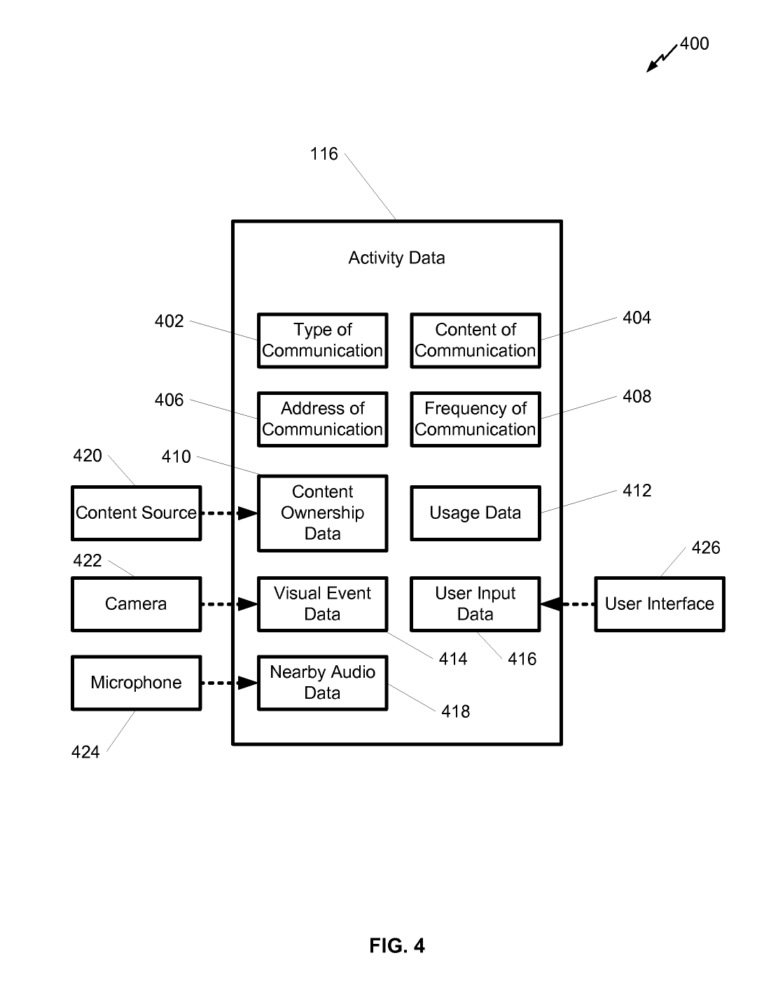

Referring to FIG. 4, a particular example of the activity data 116 of FIG. 1 is shown and is generally designated as 400. The activity data 116 may include information related to a type of communication 402, content of a communication 404, an address of a communication 406, a frequency of communication 408, content ownership data 410, usage data 412, visual event data 414, user input data 416, and/or audio data 418. The content ownership data 410 may correspond to information from a content source 420 indicating ownership of a particular content item. For example, the content ownership data 410 may indicate whether a particular content item is owned by the user to allow the playlist 110 to contain only content owned by the user or if that content can be played on a particular type of device (e.g. mobile, desktop, television, etc.). The usage data 412 may correspond to data indicating usage of a computing device (e.g., the device 102 or the computing device 200) by a user. The visual event data 414 may be responsive to an output of a camera 422, such as a captured image or video. In a particular embodiment, the camera 422 may be incorporated within a device, such as the device 102. The content source 420 may be a local content source or a remote content source, such as the content source 132 of FIG. 1. The user input data 416 may be responsive to information from a user interface 426. The user interface 426 may correspond to an input unit (e.g., the input/output unit 118 of FIG. 1 or to the input unit 202 of FIG. 2). For example, the user interface 426 may be presented to the user via a touchscreen, such as the touchscreen 204 of FIG. 2. The audio data 418 may be received from the microphone 424. In a particular embodiment, the microphone 424 corresponds to the microphone 206 of the computing device 200.

The data regarding the type of communication 402, the content of the communication 404, the address of the communication 406, and the frequency of communication 408 may be determined by a processor within the computing device. For example, the processor 104 or the processor 210 may analyze incoming/outgoing message traffic in order to determine such data items. The type of communication 402 may indicate whether a particular communication is a short message service (SMS) text message or a telephone call. The content of the communication 404 may indicate content of the SMS text message or the telephone call. SMS and telephone calls are non-limiting examples of a particular type of communication. Other types of communications may include, but are not limited to, emails, instant messages, social network messages, push notifications, etc. The address of the communication 406 may indicate a source or a destination of a particular communication. The frequency of communication 408 may indicate how often or seldom communication is made by a particular device, to the particular device, or between specific devices. The data regarding the type of communication 402, the content of the communication 404, the address of the communication 406, and the frequency of communication 408 may also indicate whether a communication was sent or received from the device 102 or the computing device 200. Thus, the activity data 116 may include a variety of different types of information that track or otherwise correspond to action associated with a user of an electronic device, such as the device 102 or the computing device 200.

The activity data 116 may include information that originates from other sensors that communicate directly with other systems. For example, the activity data 116 may include information, such as biometric data, from a health-monitoring device (e.g., a heart-rate monitor). In this example, the health-monitoring device may record and automatically transfer data (such as heart-rate data of a user) throughout the day.

The activity data 116 may also include information associated with a home security system or a home automation system. For example, the activity data 116 may indicate whether a particular lighting unit is on inside of a dwelling associated with the user. Based on whether the particular lighting unit is on, a particular media content item may be selected (e.g., a comedy show may be selected in response to all lights being turned on). In another example, the activity data may indicate whether a dwelling associated with the user is currently occupied such that a device at the dwelling is configured to not play media content when the dwelling is unoccupied. In yet another example, specific contexts known for the activity data 116 within a dwelling may create different changes to the playlist 110. For example, if only the adult members of a dwelling are consuming media content in the playlist 110, a murder mystery-based program may be selected. In another example, if both adult and children members are present in a dwelling, a family-oriented cartoon may be selected. The activity data 116 may further include information associated with a wearable computing device, such as a head-mounted display. For example, the activity data 116 may include data corresponding to eye movement patterns of the user, such as an active pattern or a focused pattern.

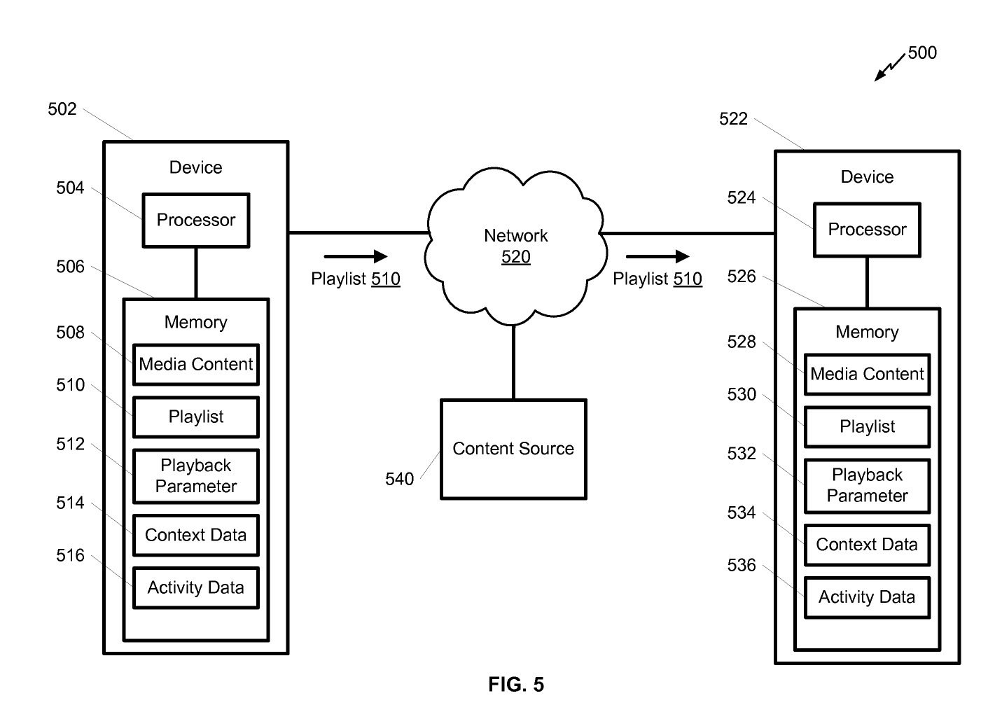

Referring to FIG. 5, a particular illustrative embodiment of a communication system 500 is shown. The communication system 500 includes a first device 502, a network 520 and a second device 522. The first device 502 may be a media playback device such as a set-top box (STB) of a user and a second device 522 may be a communication device, such as a mobile device of the user. For example, the first device 502 may be stationary or relatively stationary, such as within a residence, and coupled to a television or other display device. The second device 522 may be portable. The first device 502 and the second device 522 may be computing devices (e.g., corresponding to the device 102 or the computing device 200).

The first device 502 includes a first processor 504 and a first memory 506. The first memory 506 stores various data, such as first media content 508, a first playlist 510, a first playback parameter 512, first context data 514, and first activity data 516. Similarly, the second device 522 includes a second processor 524 and second memory 526. The second memory 526 stores various data, such as second media content 528, a second playlist 530, a second playback parameter 532, second content data 534, and second activity data 536. Each of the first device 502 and the second device 522 may be similar to the device 102 or the computing device 200. The first device 502 is coupled, via the network 520, to a remote content source 540. Similarly, the second device 522 also has access to the content source 540 via the network 520. In a particular illustrative embodiment, the network 520 may include a local area network, the internet, or another wide area network.

During operation, the first playlist 510 may be determined or modified based on information accessed and processed by the first processor 504. For example, the first processor 504 may create a personalized playlist of a user of the first device 502 based on information stored and processed at the first device 502. The first processor 504 may analyze information associated with the first media content 508, the first context data 514, and the first activity data 516, as described above, in order to customize the first playlist 510 and to determine the first playback parameter 512.

The customized playlist for the user of the first device 502 may be communicated to other devices associated with the user. For example, the first playlist 510 may be communicated via the network 520 to the second device 522 and may be stored as the second playlist 530. In this manner, dynamically modified playlists may be conveniently communicated and transferred from one device to another. Once the first playlist 510 is stored as the second playlist 530 within the second device 522, the second device 522 may access the second playlist 530 and may execute the second playlist 530 in order to provide video and/or audio output at the second device 522. Thus, the first playlist 510 may be customized for a user at one device and may distributed to other devices so that a user may enjoy content, playlists, and playback parameters in a variety of environments and via a variety of devices. In addition, the second playlist 530, once received and stored within the second memory 526, may be modified and further customized based on the second context data 534 and the second activity data 536 of the second device 522. For example, when the context or physical environment of the second device 522 changes, such as from an in-home experience to a vehicle, the second context data 530 similarly changes to reflect the new environment, and the second processor 524 may modify or otherwise update or customize the second playlist 530 based on the detected change in the second context data 534. The playlist 510 and the playlist 530 may also include content location data indicating a playback status of the content. The playback status may indicate a play time of audio/video content (e.g., a song, a video, an audio book, etc.) or a page mark of a book (e.g., a textbook, a magazine, an ebook, etc.). As another example, as the user interacts with the second device 522, the second activity data 536 changes and the second processor 524 responds to the change in the second activity data 536 in order to further modify and customize the second playlist 530 and to set the second playback parameter 532 accordingly.

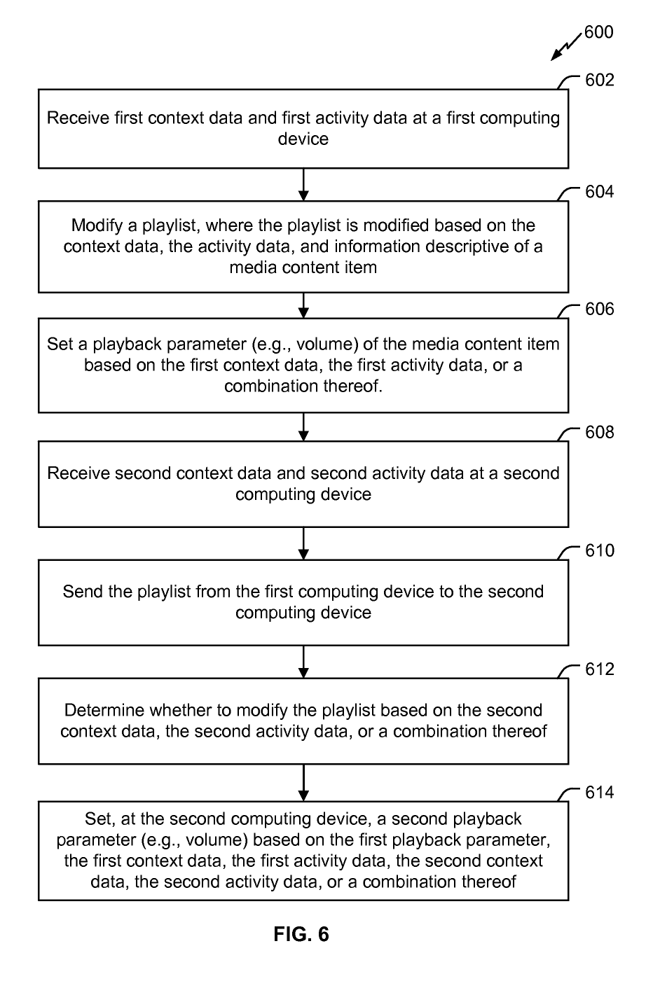

Referring to FIG. 6, a method 600 for dynamically modifying a playlist is illustrated. The method 600 includes receiving first context data and first activity data at a first computing device, at 602. The first computing device may correspond to the device 102 of FIG. 1, the computing device 200 of FIG. 2, or the first device 502 of FIG. 5. Based on the first context data, the first activity data, descriptive information about a media content item, or a combination thereof, a playlist is modified (e.g., adding or deleting a particular media content item, at 604. The method 600 further includes setting a playback parameter (e.g., volume or playback speed) of the media content based on the first context data, the first activity data, or any combination thereof, at 606. The media content, the first context data, the first activity data, and the playback parameter may be stored in the memory 106 of the device 102, as shown in FIG. 1, in the memory 212 of the computing device 200, as shown in FIG. 2, or in the memory 506 of the first device 502, as shown in FIG. 5.

The method 600 further includes receiving second context data and second activity data at a second computing device, at 608. The second computing device may correspond to the second device 522 of FIG. 5. The playlist is sent from the first computing device to the second computing device, at 610. The playlist may be sent via a network, such as the network 130 as in FIG. 1 or the network 520 of FIG. 5. After the playlist is sent, the method 600 includes determining whether to modify the playlist based on the second context data, the second activity data, or a combination thereof, at 612. After the determination, the second computing device sets a second playback parameter based on the first playback parameter, the first context data, the first activity data, the second context data, the second activity data, or any combination thereof, at 614.

Thus, embodiments of a system and method of dynamically selecting media (e.g., audio, video, or both) for a playlist based on activity data that indicates user interactions (e.g., within a home or with a mobile device) along with the users media preferences have been described. The interactions can be detected based on user activities (e.g., turning on lights, changing the temperature, opening doors, etc.), speech interactions (e.g., the tone of someone's conversations on a phone or face-to-fact, a speaker, content of speech), passive computer vision observations (such as in-home cameras, e.g., to determine if someone is excited or tired, to observe facial expression, or to observe activity in the users environment), and digital activities (e.g., phone calls or emails, media purchases from music/video stores, channel change information from a media service). Thus, the embodiments of the system and method of dynamically selecting media for a playlist may utilize various aspects of a user's activities detected by a device to dynamically select the media for the playlist.

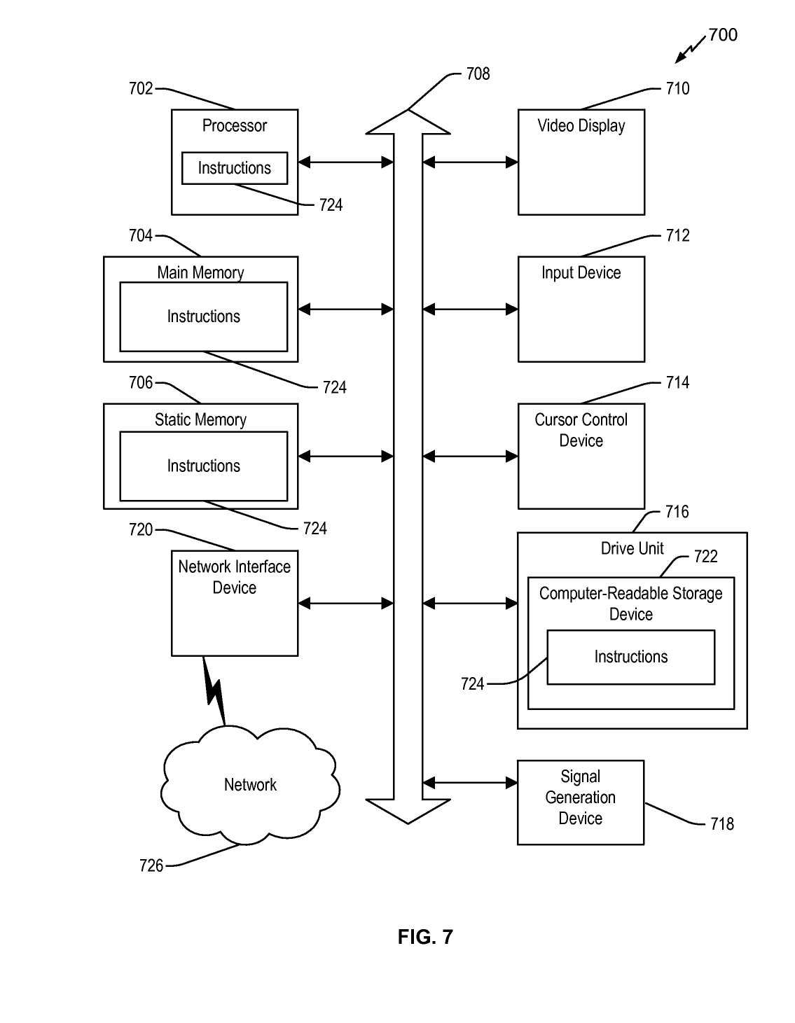

FIG. 7 illustrates a particular embodiment of a general computer system 700 including components that are operable to estimate image quality. The general computer system 700 may include a set of instructions that can be executed to cause the general computer system 700 to perform any one or more of the methods or computer based functions disclosed herein. The general computer system 700 may operate as a standalone device or may be connected, e.g., using a network, to other computer systems or peripheral devices. For example, the general computer system 700 may include, may be included within, or correspond to one or more of the components of the device 102, the computing device 200, the first device 502, the second device 522, the content source 134, or any combination thereof.

In a networked deployment, the general computer system 700 may operate in the capacity of a server or as a client user computer in a server-client user network environment, or as a peer computer system in a peer-to-peer (or distributed) network environment. The general computer system 700 may also be implemented as or incorporated into various devices, such as a mobile device, a laptop computer, a desktop computer, a communications device, a wireless telephone, a personal computer (PC), a tablet PC, a set-top box, a customer premises equipment device, an endpoint device, a web appliance, or any other machine capable of executing a set of instructions (sequential or otherwise) that specify actions to be taken by that machine. In a particular embodiment, the general computer system 700 may be implemented using electronic devices that provide video, audio, or data communication. Further, while one general computer system 700 is illustrated, the term “system” shall also be taken to include any collection of systems or sub-systems that individually or jointly execute a set, or multiple sets, of instructions to perform one or more computer functions.

As illustrated in FIG. 7, the general computer system 700 includes a processor (or controller) 702, e.g., a central processing unit (CPU), a graphics processing unit (GPU), or both. Moreover, the general computer system 700 may include a main memory 704 and a static memory 706, which can communicate with each other via a bus 708. As shown, the general computer system 700 may further include a video display unit 710, such as a liquid crystal display (LCD), a light emitting diode (LED) display, a touch screen display, a flat panel display, a solid-state display, or a lamp assembly of a projection system. Additionally, the general computer system 700 may include an input device 712, such as a keyboard, and a cursor control device 714, such as a mouse. In some embodiments, the input device 712 and the cursor control device 714 may be integrated into a single device, such as a capacitive touch screen input device. The general computer system 700 may also include a drive unit 716, a signal generation device 718, such as a speaker or remote control, and a network interface device 720. The general computer system 700 may be operable without an input device (e.g., a server may not include an input device).

In a particular embodiment, as depicted in FIG. 7, the drive unit 716 may include a computer-readable storage device 722 in which one or more sets of data and instructions 724, e.g. software, can be embedded. The computer-readable storage device 722 may include random access memory (RAM), read-only memory (ROM), programmable read-only memory (PROM), erasable PROM (EPROM), electrically erasable PROM (EEPROM), register(s), solid-state memory, hard disk, a removable disk, a compact disc read-only memory (CD-ROM), other optical disk storage, magnetic disk storage, magnetic storage devices, or any other storage device that can be used to store program code in the form of instructions or data and that can be accessed by a computer and/or processor. A computer-readable storage device is not a signal. Further, the instructions 724 may embody one or more of the methods or logic as described herein. The instructions 724 may be executable by the processor 702 to perform one or more functions or methods described herein, such as dynamically modifying a playlist based on context data and activity data. In a particular embodiment, the instructions 724 may reside completely, or at least partially, within the main memory 704, the static memory 706, and/or within the processor 702 during execution by the general computer system 700. The main memory 704 and the processor 702 also may include a computer-readable storage device.

In an alternative embodiment, dedicated hardware implementations, such as application specific integrated circuits, programmable logic arrays and other hardware devices, may be constructed to implement one or more of the methods described herein. Various embodiments may broadly include a variety of electronic and computer systems. One or more embodiments described herein may implement functions using two or more specific interconnected hardware modules or devices with related control and data signals that can be communicated between and through the modules, or as portions of an application-specific integrated circuit (ASIC). Accordingly, the present system encompasses software, firmware, and hardware implementations.

In accordance with various embodiments of the present disclosure, the methods described herein may be implemented by software programs executable by a computer system, a processor, or a device, which may include forms of instructions embodied as a state machine, such as implementations with logic components in an ASIC or a field programmable gate array (FPGA) device. Further, in an exemplary, non-limiting embodiment, implementations may include distributed processing, component/object distributed processing, and parallel processing. Alternatively, virtual computer system processing may be used to implement one or more of the methods or functionality as described herein. It is further noted that a computing device, such as a processor, a controller, a state machine or other suitable device for executing instructions to perform operations or methods may perform such operations directly or indirectly by way of one or more intermediate devices directed by the computing device.

A computer-readable storage device 722 may store the data and instructions 724 or receive, store, and execute the data and instructions 724, so that a device may perform dynamic playlist modification as described herein. For example, the computer-readable storage device 722 may include or be included within one or more of the components of the device 102. While the computer-readable storage device 722 is shown to be a single device, the computer-readable storage device 722 may include a single device or multiple devices, such as a distributed processing system, and/or associated caches and servers that store one or more sets of instructions. The computer-readable storage device 722 is capable of storing a set of instructions for execution by a processor to cause a computer system to perform any one or more of the methods or operations disclosed herein.

In a particular non-limiting, exemplary embodiment, the computer-readable storage device 722 may include a solid-state memory such as embedded memory (or a memory card or other package that houses one or more non-volatile read-only memories). Further, the computer-readable storage device 722 may be a random access memory or other volatile re-writable memory. Additionally, the computer-readable storage device 722 may include a magneto-optical or optical device, such as a disk or tapes or other storage device. Accordingly, the disclosure is considered to include any one or more of a computer-readable storage device and other equivalents and successor devices, in which data or instructions may be stored.

Although one or more components and functions may be described herein as being implemented with reference to a particular standard or protocols, the disclosure is not limited to such standards and protocols. In addition, standards are from time-to-time superseded by faster or more efficient equivalents having essentially the same functions.

In an example embodiment, a method includes obtaining, at a computing device, context data including information indicating a context associated with a user and obtaining, at the computing device, activity data including information indicating an activity of the user. The method also includes adding a media content item to a playlist, wherein the content item is added to the playlist based on information descriptive of the media content item, the context data, and the activity data. The method further includes setting, at the computing device, a playback parameter of the media content item based on the context data, the activity data, or any combination thereof.

In another example embodiment, a system includes a processor and a memory comprising instructions that, when executed by the processor, cause the processor to execute operations. The operations include obtaining context data including information indicating a context associated with a user and obtaining activity data including information indicating an activity of the user. The operations also include adding a media content item to a playlist, wherein the content item is added to the playlist based on information descriptive of the media content item, the context data, and the activity data. The operations further include setting a playback parameter of the media content item based on the context data, the activity data, or any combination thereof.

In another example embodiment, a computer-readable storage device is disclosed. The computer-readable storage device comprises instructions that, when executed by the processor, cause the processor to execute operations. The operations include obtaining context data including information indicating a context associated with a user and obtaining activity data including information indicating an activity of the user. The operations also include adding a media content item to a playlist, wherein the content item is added to the playlist based on information descriptive of the media content item, the context data, and the activity data. The operations further include setting a playback parameter of the media content item based on the context data, the activity data, or any combination thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Figures are also merely representational and may not be drawn to scale. Certain proportions thereof may be exaggerated, while others may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order or function unless expressly stated. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

In one or more embodiments, a processor (which can include a controller or circuit) has been described that performs various functions. It should be understood that the processor can be implemented as multiple processors, which can include distributed processors or parallel processors in a single machine or multiple machines. The processor can be used in supporting a virtual processing environment. The virtual processing environment may support one or more virtual machines representing computers, servers, or other computing devices. In such virtual machines, components such as microprocessors and storage devices may be virtualized or logically represented. The processor can include a state machine, an application specific integrated circuit, and/or a programmable gate array (PGA) including a Field PGA. In one or more embodiments, when a processor executes instructions to perform “operations,” this can include the processor performing the operations directly and/or facilitating, directing, or cooperating with another device or component to perform the operations.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method comprising:
obtaining, at a device, context data including information indicating a context associated with a user;
obtaining, at the device, activity data including information indicating an activity of the user;
modifying a playlist, wherein the playlist is modified based on the context data, the activity data, and information descriptive of a media content item; and
setting, at the device, a playback parameter of the media content item based on the context data, the activity data, or a combination thereof.

2. The method of claim 1, further comprising:
obtaining, at a second device, second context data including information indicating a second context associated with the user;
obtaining, at the second device, second activity data including information indicating a second activity of the user;
sending the playlist to the second device;
determining whether to modify the playlist based on the second context data, the second activity data, or a combination thereof; and
setting, at the second device, a second playback parameter of the media content based on the playback parameter, the context data, the activity data, the second context data, the second activity data, or any combination thereof.

3. The method of claim 1, further comprising determining the information descriptive of the media content item by analyzing the media content item to determine a plurality of characteristics of the media content item, wherein the plurality of characteristics of the media content item includes a playback duration of the media content item and a format of the media content item.

4. The method of claim 1, wherein the context data indicates a geographic location of the user, a point of interest proximate to the user, a movement of the user, a travel mode of the user, a schedule of the user, a weather status of the geographic location, a time, a mood of the user, or any combination thereof.

5. The method of claim 1, wherein the activity data indicates an interaction event corresponding to an interaction of the user with a device.

6. The method of claim 5, wherein the device includes a communication device and wherein, in the activity data, the interaction event is indicated by data descriptive of a type of communication performed using the communication device, content of a communication sent via the communication device, content of a communication received via the communication device, a frequency of communication via the communication device, an address associated with a communication sent by the communication device, an address associated with a communication received by the communication device, or any combination thereof.

7. The method of claim 1, wherein the activity data indicates a speech event corresponding to speech detected proximate to the device, a visual event corresponding to image information detected proximate to the device, or any combination thereof.

8. The method of claim 7, wherein, in the activity data, the speech event is indicated by data descriptive of content of detected speech, a tone of detected speech, a recognized speaker of the detected speech, or any combination thereof.

9. The method of claim 7, wherein, in the activity data, the visual event is indicated by data descriptive of a facial expression of the user, a facial expression of a person proximate to the user, an activity proximate to the user, an identification of persons proximate to the user, an identification of surroundings of the user, or any combination thereof.

10. The method of claim 1, wherein the activity data indicates biometric data associated with the user of the device.

11. The method of claim 1, further comprising providing a recommendation for modifying the playlist, wherein the recommendation is based on the context data, the activity data, the information descriptive of the media content item, or any combination thereof.

12. The method of claim 1, wherein the playback parameter includes audio volume, display brightness, a caption overlay, or any combination thereof.

13. The method of claim 1, further comprising outputting the media content item to an output unit based on the playback parameter, wherein the output unit comprises a display, a speaker, or any combination thereof.

14. A system comprising:
a processor; and
a memory comprising instructions that, when executed by the processor, cause the processor to execute operations comprising:
obtaining context data including information indicating a context associated with a device of a user;
obtaining activity data including information indicating an activity of the user;
modifying a playlist, wherein the playlist is modified based on the context data, the activity data, and information descriptive of a media content item; and
setting, at the device, a playback parameter of the media content item based on the context data, the activity data, or a combination thereof.

15. The system of claim 14, further comprising a location sensor, wherein the location sensor provides location information, and wherein the context data includes the location information.

16. The system of claim 14, further comprising:
a user input interface configured to receive user input;
a microphone configured to receive an audio input; and
a camera configured to receive a visual input;
wherein the activity data is based on the user input, the audio input, the visual input, or any combination thereof.

17. The system of claim 14, further comprising:
a display configured to output a visual output, wherein the visual output is based on the playback parameter; and
a speaker configured to output an audio output, wherein the audio output is based on the playback parameter.

18. The system of claim 14, further comprising a network interface configured to receive the media content item via a network.

19. A computer-readable storage device comprising instructions that, when executed by a processor, cause the processor to execute operations comprising:
obtaining context data including information indicating a context associated with a device of a user;
obtaining activity data including information indicating an activity of the user;
modifying a playlist, wherein the playlist is modified based on the context data, the activity data, and information descriptive of a media content item; and
setting, at the device, a playback parameter of the media content item based on the context data, the activity data, or a combination thereof.

20. The computer-readable storage device of claim 19, wherein the operations further comprise retrieving the media content item from a content source via a network.
